(19) United States
(12) Patent Application Publication
(10) Pub. No.: US 2010/0236383 A1
(43) Pub. Date: Sep. 23, 2010

(54) Living organism controlled music generating system

(76) Inventor: PETER SAMUEL VOGEL, SYDNEY (AU)

Correspondence Address: PETER VOGEL, 30 ADELINE STREET, FAULCONBRIDGE, 2776, AU

(21) Appl. No.: 12/724,436

(22) Filed: Mar. 16, 2010

(30) Foreign Application Priority Data
Mar. 20, 2009 (AU) 2009901133

(51) Int. Cl. G10H 1/00

(52) U.S. Cl. 84/600

(57) ABSTRACT

A music synthesising system wherein the musical output is responsive to the normal activities of a living organism. In one example, electrical activity within the cells of a living plant is used to trigger and modulate a music synthesiser. In another example, the movements of a bird in a cage as sensed by a video camera are used to trigger and modulate a music synthesiser.

### FIELD OF THE INVENTION

The present invention relates to electronic systems for creating music.

### BACKGROUND OF THE INVENTION

Musical instruments conventionally require a human player to cause them to create music. A limited range of instruments generate music autonomically. For example a music box once wound up will play a predetermined tune which will always be the same each time it plays. A wind chime produces ever-changing music so long as gusts of wind activate it, and while pleasing, the music is substantially random and does not have interesting, recognisable variations.

### SUMMARY OF THE INVENTION

It is an object of this invention to provide a system for automatically producing music which is responsive to the usual activities of a living organism.

According to one aspect, the present invention comprises the steps of sensing an activity or condition of a living organism which is not intending to play music, and generating note events responsive to said sensed activity or condition. For example the living organism can be an animal or plant and the step of sensing an activity can be detecting electrical activity within said organism. In another example, the step of sensing an activity is detecting movement of part or all of the organism.

According to another aspect of the invention, a sensed condition such as ambient temperature or organism temperature can be sensed and used to control or modulate the music produced by the invention.

According to an extension of the inventive concept, the invention further comprises the step of synthesising music responsive to said note events.

In some embodiments of the invention, the step of generating note events involves selecting notes from a table of notes according to the sensed activity or condition.

The table of notes can be, for example, a pentatonic scale or other scale comprosong notes which sound pleasant irrespective of which other note in the scale precedes or follows it.

In other embodiments of the invention, the step of generating note events involves selecting a note sequence from a table of note sequences according to the sensed activity or condition. The table of note sequences can be, for example, a table containing arpeggios, short melodies or other interesting musical phrases.

In yet other embodiments, the step of generating note events involves applying a music composition algorithm to inputs derived from the sensed activity or condition.

The invention also consists in apparatus for performing the above steps.

### DESCRIPTION OF PREFERRED EMBODIMENTS

Embodiments of the invention will now be described with reference to the drawings in which:

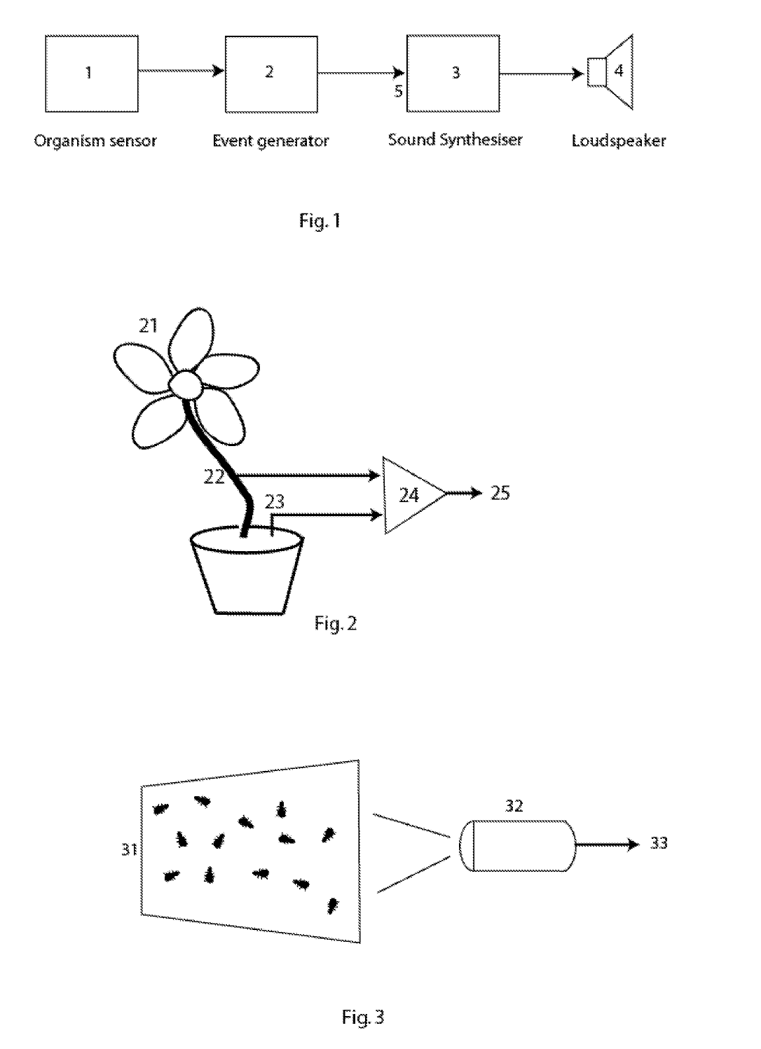

FIG. 1 is a block diagram of an embodiment of the present invention;

FIG. 2 is a block diagram of an embodiment of the present invention utilising a plant as the controlling organism; and

FIG. 3 is a block diagram of an embodiment of the present invention utilising an ant colony as the controlling organism

Referring now to FIG. 1, the general form of the invention is shown schematically. Organism sensor 1 can be any means for sensing activity of a living organism. Some examples of organism sensors which can be used in this invention to good effect include:
1. Infra-red temperature sensor which senses the temperature of an organism. Cold-blooded animals can be sensed with good effect as they exhibit interesting cyclical body temperature variations.
2. One or more strain gauges connected to a bean plant or petals of a flower which sense circadian movements of such plants.
3. Vibration sensors which detect locomotion of animals ranging from cockroaches to frogs.
4. Wave sensors which detect ripples on a fish tank as the fish swim about.
5. Optical sensors which detect movement of animals in a confined space.
6. pH or other chemical sensors which detect chemical changes in a nutrient medium in which organisms are growing.
7. Video-microscope detecting cell divisions.
8. Light-beam or passive infra-red sensors detecting movement of animals within a defined area, for example people walking around a room or puppies at play.
9. Acoustic sensor detecting sound created by organisms or their environment, for example white-ants eating wood, birds singing, a dog panting, or a human heartbeat.
10. Colour sensitive sensors detecting changes in colour of an organism.
11. Electrical potential sensors detecting potential in certain parts of plants or animals, such as cells within a plant, muscles in an animal or brain activity in an animal.
12. Gas sensors detecting gas levels within or near an organism, such as oxygen concentration near an organism inside a container or oxygen saturation in the bloodstream of an animal.
13. Sensor measuring electrical conductivity of an organism or part thereof.
14. Ultrasonic sensor measuring internal characteristics of an organism such as movement of internal organs, blood flow or respiration.
15. Sensor measuring characteristics of an organism's environment such as moisture of soil in which a plant is growing.

It will be understood that the above list is by no means exhaustive and any sensor capable of detecting changes within or caused by a living organism can be used without departing from the scope of the invention.

In some embodiments of the invention, multiple sensors of the same or different types are used in combination. For example the organism might be a plant and one sensor is used to measure conductivity and another used to measure position of a leaf.

The output of organism sensor 1 is used to control event generator 2. Responsive to the input from organism sensor 1, event generator 2 generates at its output a signal defining a musical event. A musical event is typically a data packet comprising sound information, pitch information and duration information. For convenience, event generator 2 can be implemented as software within a microprocessor. Algorithms within event generator 2 define a relationship between the input from organism sensor 1 and the detail of the generated music event. In one embodiment, the output of event generator 2 conforms to the well-known MIDI (Musical Instrument Digital Interface) standard. MIDI data packets typically include pitch, duration, velocity and channel information. In the case of this invention, the velocity information can be used to convey the volume of an event and channel information can define which sound (also commonly known as voice) the packet causes to trigger.

The algorithm mapping organism sensor input to event output determines the perceived musical quality of the invention, however any algorithm can be used without departing from the scope of the invention. It is however preferable that the algorithm be selected with care to produce the most musically interesting results. Some exemplary algorithms will now be described.

### Wind chime algorithm

This embodiment results in a sound similar to wind chimes, except that the music produced is responsive to the activity of the sensed living organism, rather than the wind. The channel number output by event generator 2 is chosen so that a chime sound is generated by sound synthesiser 3 (described below).

The algorithm maps the sensor input to one of a small set of permitted notes. For example, the set of permitted notes might be:
1. major pentatonic scale (e.g. C D E G A)
2. minor pentatonic scale (e.g. C Eb F G Bb) or other pleasant sounding combination.
In a variation of this embodiment, multiple notes can be output simultaneously. In some cases this might be triggered by a single input quantity. For example, the input sensor could be a vibration sensor detecting the footsteps of a mouse, and the amplitude of the vibration could be quantised to 5 levels, each level being mapped to one of 25 pairs of 5 permitted notes. In other cases multiple inputs can be utilised. For example the floor of a mouse cage could be fitted with two vibration sensors at opposite ends and the inputs from these quantised independently, each triggering one of five permitted notes, so that single notes or pairs of notes may sound as the mouse runs about.

### Preset Melody Algorithm

In this case, one or more sequences of notes are stored and triggered by the sensed input. In one of the simplest examples of this algorithm, the notes making up a tune such as “Jingle bells” is stored and the sensed activity causes the event generator to output the corresponding events. In this way the music created could respond to, say, the movement of a fish in a fishbowl so that when the fish moves more than a prescribed amount in a given time, the music starts and the tempo of the music is then proportional to the degree of activity of the fish. In a more complex implementation, the sensed input can control tempo, loudness and transposition of the tune played. Characteristics other than movement can also be sensed, for example in a tank in which different coloured fish are swimming, the colour of the fish passing a particular location is sensed by a camera and determines the key in which a melody is played, or which of several melodies is played.

### Calculated Melody algorithm

Sequences of events are generated according to a function of the sensed input. For example, a “blues” algorithm uses a blues scale (tonic, flattened third, fourth, flattened fifth, fifth, flattened seventh). Responsive to the sensed input, rhythmic or melodic variations are created. For example, movement of fish in a bowl could be sensed and applied as input to the algorithm, each fish being assigned to control one of key (selected from a small set of say three key signatures), rhythm (selected from a set of prescribed rhythm patterns) or melody (sequential selection of pitches within the current scale). There are many other methods of generating calculated melodies known to the computer music art which can be used with good results. One example of a suitable calculated melody algorithm well known in the art is fractal music, whereby a compositional seed is processed by a fractal algorithm. The present invention can use a sensed input to vary the seed and/or the fractal algorithm parameters.

### Percussion Algorithm

In this example of the invention, synthesiser 3 is adapted to produce one or more percussion instrument sounds. An algorithm executed by event generator 2 outputs a sequence of events which when mapped to the percussion instruments causes the invention to produce rhythmic percussion music, sounding, for example, like a drum kit, a gamelan orchestra, tabla players and so on. One simple algorithm that can be used with good effect produces events triggering different percussion sounds at different but related tempi, the result being polyrhythms. For example, two drums could be synthesised, one at 3 beats to the bar and the other at 4 beats to the bar. The sensed organism input to event generator 2 is used to modify the two patterns, for example by omitting particular beats within the bar according to the input.

These methods of generating music are well known to the electronic music art, however according to this invention, the event generating algorithms take as an input the output of organism sensor 1, so that the music created is responsive to the activities of the sensed organism. For example, the algorithm might create two wood-block sounds, pitched one fifth apart, each playing an eight-beat pattern at 100 beats per minute. Inputs from the organism sensor is used to gate the beats of each sound. To further enhance the musical interest, the tempo and volume of the sounds can also be controlled by the sensed organism. More complex rhythms can be produced by combining patterns of different beats to the bar, for example 3 against 4. More interesting music can be created by algorithms which produce patterns with longer repeat times.

### Nature Sounds

In this example, sound synthesiser 3 generates sounds of nature, for example waves crashing, water dripping, wind rustling leaves, crickets chirping, bird song, etc. Event generator 2 controls these sounds, for example by triggering a short water-drop sound or modulating the amplitude of a rustling sound, responsive to input from organism sensor 1. Sound synthesiser 3 can generate the sounds using electronic synthesis, by replaying stored sample of sounds, or any other technique. One example of such an embodiment of the invention uses a vibration sensor to detect movements of one or more fish in a bowl. Sound synthesiser 3 comprises memory in which samples of seaside sounds are stored, including, for example, lapping water, crashing waves, and seagull calls. Event generator 2 monitors the sensed vibration caused by fish movements and applies to them suitable algorithms to detect certain classes of movement, and generate musical events in response. For example, the relationship between fish movements and synthesised sound can be:
1. Fish nearly stationary: quiet water lapping
2. Fish swimming slowly (low frequency vibrations): waves crashing, amplitude proportional to frequency of vibration
3. Fish swimming quickly (high frequency vibrations): periodic seagull calls.

In practice, more complex algorithms could be used to create more interesting soundscapes. Musical melodies or percussion of various types can also be included to further enhance the result. Additional sensors, such as water temperature or ambient light can be used to further modulate the output in response to environmental changes.

Referring now to FIG. 2, an example of a suitable organism sensor of the invention is shown, in which the organism sensed is a living plant. In this example, plant 21 is a flower to which electrode 22 is attached for detecting electrical activity. Electrode 23 is a reference electrode and the potential across the two electrodes is amplified by differential amplifier 24, the output of which at 25 corresponds to output of organism sensor 1 of FIG. 1. The potential across plant 21 varies in response to the biological and chemical processes within the living plant. These signals comprise both short term (high frequency) and long term (low frequency) signals. These signals can be used in a variety of ways to control event generator 2. For example, the high frequency components can be used to trigger quantised note values and the low frequency components used to control the tempo or volume of the music.

It has been found experimentally that the signals found in many plants vary in response to environmental factors, external stimuli, circadian rhythms and so on. The music produced is therefore influenced by the plant's internal and external environment.

Referring now to FIG. 3, an example of a suitable organism sensor of the invention is shown, in which the organisms sensed are ants in an ant farm. Ant farm 31 is a transparent enclosure in which the ants live. Camera 32 captures images of the ants as they go about their daily lives. The output 33 of camera 32 provides input to event generator 2 of FIG. 1. By suitably processing the output of camera 32, event generator 2 can extract certain features which are used to control the event generating algorithms.

For example, speed, direction and distance of movement can be used to control tempo, pitch and amplitude of the synthesised music. Camera 32 can be any type of image sensor for example a high-resolution charge coupled device, or a low resolution sensor such as used as a movement sensor in optical mouse applications. Camera 32 can also be a collection of discrete optical sensors, for example a 4×4 array of phototransistors onto which the image is focused, discrete phototransistors disposed across the surface of the ant farm, or optical sensors at the periphery of the ant farm paired with light infra-red or visible light sources such that ants moving in certain areas interrupt the beam. Alternatively, a smaller number of optical receivers can be used in combination with an array of multiplexed light sources.

In another variant of this embodiment, vibration transducers can be used to sense the movement of the ants. To provide more easily measurable vibration, larger organisms such as frogs (in a suitable enclosure) might be used.

It will be understood by those skilled in the art that many combinations of organisms, sensors and music algorithms can be used with good results in practising this invention.

It will also be understood that while certain preferred embodiments are described above, many variations can be made without departing from the scope of the invention.

For example, whereas the invention is described as using sensed input from a living organism to control the generated sounds, it will be understood that the invention can also be practised with good results using sensed input from non-living sources such as environmental sensors responsive to humidity, light, wind, vibration etc. For example movements of a flag fluttering in the breeze could be sensed instead of organism sensor 1.

In other embodiments a combination of living and non-living sources can be sensed and used as inputs to control the synthesised sound.

1. A music generating method comprising the steps of sensing an activity of a non-human living organism, and generating note events responsive to said sensed activity.

2. A music generator comprising means for sensing an activity of a non-human living organism, and means for generating note events responsive to said sensed activity.

3. A music generator substantially as described herein with reference to the accompanying drawings.
